(19) United States
(12) Patent Application Publication
(10) Pub. No.: US 2015/0206028 A1
(43) Pub. Date: Jul. 23, 2015

(54) POINT CLOUD REDUCTION APPARATUS, SYSTEM, AND METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); PENG XIE, Shenzhen (CN)

(21) Appl. No.: 14/598,358

(22) Filed: Jan. 16, 2015

(30) Foreign Application Priority Data
Jan. 20, 2014 (CN) 201410026045.6

(51) Int. Cl. G06K 9/52; G06K 9/46; G06T 11/20

(52) U.S. Cl. CPC G06K 9/52; G06T 11/20; G06K 9/46; G06K 9/4604; G06K 2009/4666

(57) ABSTRACT

In a point cloud reduction method, a point cloud model and a predetermined reduction ratio are received, and a boundary box of the point cloud model is computed and divided into a plurality of grids according to the predetermined reduction ratio. A point set which includes points in the one or more adjacent grids is obtained and a plane which intersects with a center point of the point set and takes a feature vector of the point set as a normal vector is constructed. A curvature of each point in the point set to the constructed plane is computed, and then an average curvature is computed according to the curvature of each point. Points can be deleted from the point set according to differences between the curvatures of the points in the point cloud model with the average curvature, to generate a reduced point cloud model.

### CROSS-REFERENCE TO RELATED APPLICATIONS

This application claims priority to Chinese Patent Application No. 201410026045.6 filed on Jan. 20, 2014, the contents of which are incorporated by reference herein.

### FIELD

The subject matter herein generally relates to a data processing technology, and more specifically relates to an apparatus, a method and a system of reducing point clouds.

### BACKGROUND

Three-dimensional (3D) scanners measure a large number of points on a surface of an object, and outputs a point cloud as a data file. In a 3D coordinate system, points in the point cloud are usually defined by X, Y, and Z coordinates, and represent the external surface of an object. The point clouds can be used for many purposes, such as creating 3D CAD models for manufactured parts, for example.

Usually, the point cloud may contain many points, such as, hundreds of thousands, several million, even several billion. Thus, a procedure of creating the 3D CAD model will take long time. Furthermore, the points of the point cloud may be redundant, even inaccurate.

### BRIEF DESCRIPTION OF THE DRAWINGS

Implementations of the present technology will be described, by way of example only, with reference to the attached figures.

FIG. 1 is a block diagram of one embodiment of a hardware environment for executing a point cloud reduction system.

FIG. 2 is a block diagram of one embodiment of function modules of the point cloud reduction system in FIG. 1.

FIG. 3 is a flowchart of one embodiment of a point cloud reduction method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

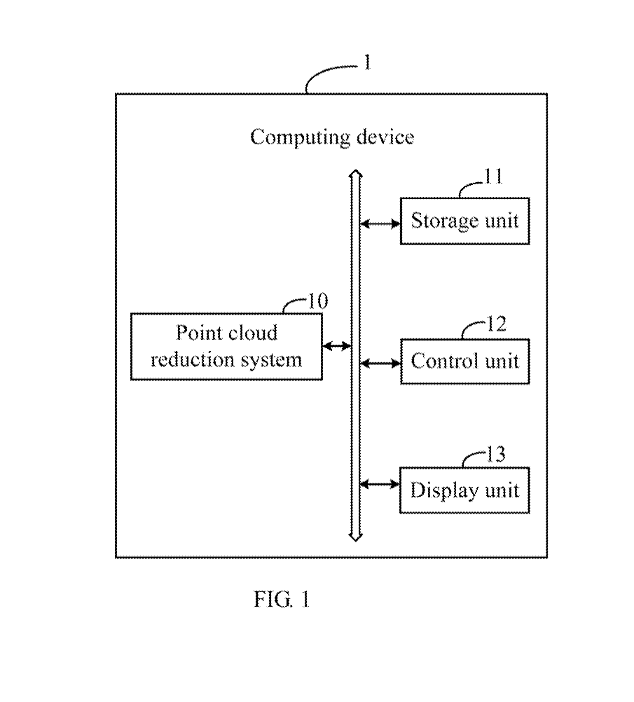

FIG. 1 is a block diagram of one embodiment of a hardware environment for executing a point cloud reduction system 10. The point cloud reduction system 10 is installed and runs in an apparatus, for example a computing device 1. The computing device 1 can include a storage unit 11, a control unit 12, and a display unit 13.

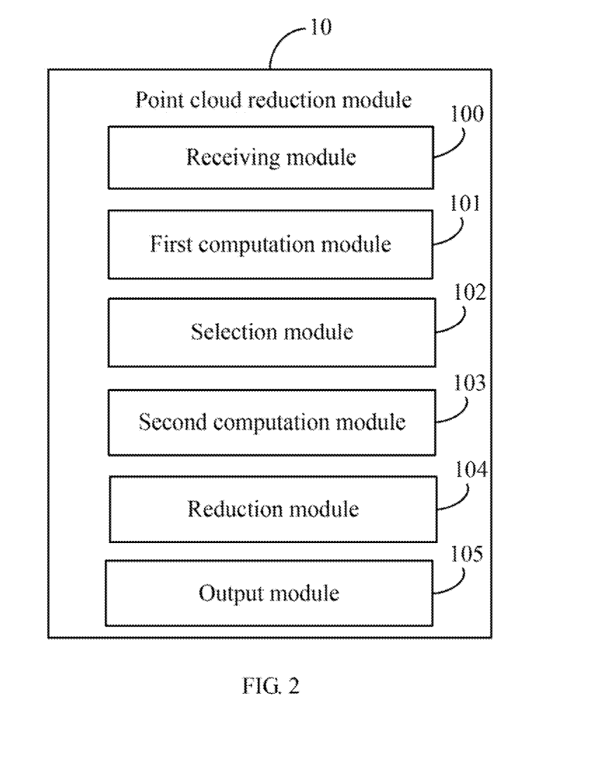

The point cloud reduction system 10 can include a plurality of function modules (as shown in FIG. 2) that reduces redundant or inaccurate points in a point cloud model.

The storage unit 11 can include some type(s) of non-transitory computer-readable storage medium, for example a hard disk drive, a compact disc, a digital video disc, or a tape drive. The storage unit 11 stores computerized codes of the function modules of the point cloud reduction system 10.

The control unit 12 can be a processor, an application-specific integrated circuit (ASIC), or a field programmable gate array (FPGA), for example. The control device 12 can execute the computerized codes of the function modules of the point cloud reduction system 10 to realize the functions of the point cloud reduction system 10.

The display unit 13 can display visible data, such as images.

FIG. 2 is a block diagram of one embodiment of the function modules of the point cloud reduction system 10. The function modules can include a receiving module 100, a first computation module 101, a selection module 102, a second computation module 103, a reduction module 104, and an output module 105.

The receiving module 100 can receive a point cloud model, and receive a predetermined reduction ratio. In one embodiment, the point cloud model can be created by a three-dimensional (3D) scanner which communicates with the computing device 1. The 3D scanner measures a large number of points on surfaces of an object. The points are defined by X, Y, and Z coordinates in a coordinate system, and intended to represent an external surface of the object. The point cloud model represented by the X, Y, and Z coordinates can be stored into the storage unit 11 of the computing device 1, and the receiving module 100 can receive a point cloud model from the storage unit 11. The predetermined reduction ratio can be received according to a user input, and may be 40 percent, for example, which means 40 percentage points need be reduced from the point cloud model.

The first computation module 101 can compute a boundary box of the point cloud model, and divide the boundary box into a plurality of grids according to the predetermined reduction ratio. Specifically, the first computation module 101 identifies a point which has a minimum coordinate and a point which has a maximum coordinate of the point cloud model, and determines a boundary box that can confine all points in the point cloud model according to the identified points. For example, the point which has the minimum coordinate is (pt1Min[x], pt1Min[y], pt1Min[z]), and the point which has the maximum coordinate is (pt1Max[x], pt1Max[y], pt1Max[z]) , then, the boundary box is a cube defined by coordinates (pt1Min[x], pt1Min[y], pt1Min[z]), (pt1Min[x], pt1Min[y], pt1Max1[z]), (pt1Min[x], pt1Max[y], pt1Min1[z]), (pt1Min[x], pt1Max[y], pt1Max[z]), (pt1Max[x], pt1Max[y], pt1Max[z]), (pt1Max[x], pt1Max[y] , pt1Min[z]), (pt1Max [x], pt1Min[y], pt1Max [z]), and (pt1Max[x], pt1Min[y], pt1Min[z]). In one embodiment, the first computation module 101 divides the boundary box into a plurality of grids according to a step D=³\sqrt{∂L³/n}, wherein “n” represents a total number of the points in the point cloud model, L represents a length of the boundary box, and ∂ represents the predetermined reduction ratio.

The selection module 102 can select one grid or more adjacent grids. In one embodiment, after dividing the boundary box into a plurality of grids, the first computation module 101 may assign an identity (ID) to each grid in sequence, and the selection module 102 can select the grid(s) according to the ID of each grid. In one embodiment, a total number of the selected adjacent grids may be 2 to 27.

The second computation module 103 can obtain a point set which includes points in the selected grid(s), and construct a plane, the plane intersecting with a center point of the point set and taking a feature vector of the point set as a normal vector. In one embodiment, the center point of the point set is O=(ΣXᵢ/n) represents a coordinate of each point in the point cloud model, and n represents a total number of the points in the point cloud model. The feature vector of the point set is a feature vector of a minimum value in a covariance matrix V=Σ(Xᵢ−O)*(Xᵢ−O)^{T}.

The second computation module 103 can compute a curvature of each point in the point set to the constructed plane, and compute an average curvature according to the curvature of each point. In one embodiment, the curvature of each point can be computed using formulas as follows:

f(Xᵢ)=Σfⱼ(Xᵢ))/n;

fⱼ(Xᵢ)=dⱼ/λⱼ;

λⱼ=∥(Xᵢ−O)*t∥;

In the above formulas, dj represents a distance between the point Xi and the constructed plane.

The reduction module 104 can compute differences between the curvatures of the points in the point cloud model with the average curvature, and determine one or more points that are needed to be deleted from the point set according to the difference. In one embodiment, when a difference between the curvatures of a point P in the point cloud model and the average curvature is more than a predetermined value, the reduction module 104 determines to delete the point P from the point cloud model. Thus a reduced point cloud can be generated.

The output module 105 can output the reduced point cloud. In one embodiment, the reduced point cloud can be displayed on the display unit 13 of the computing device 1.

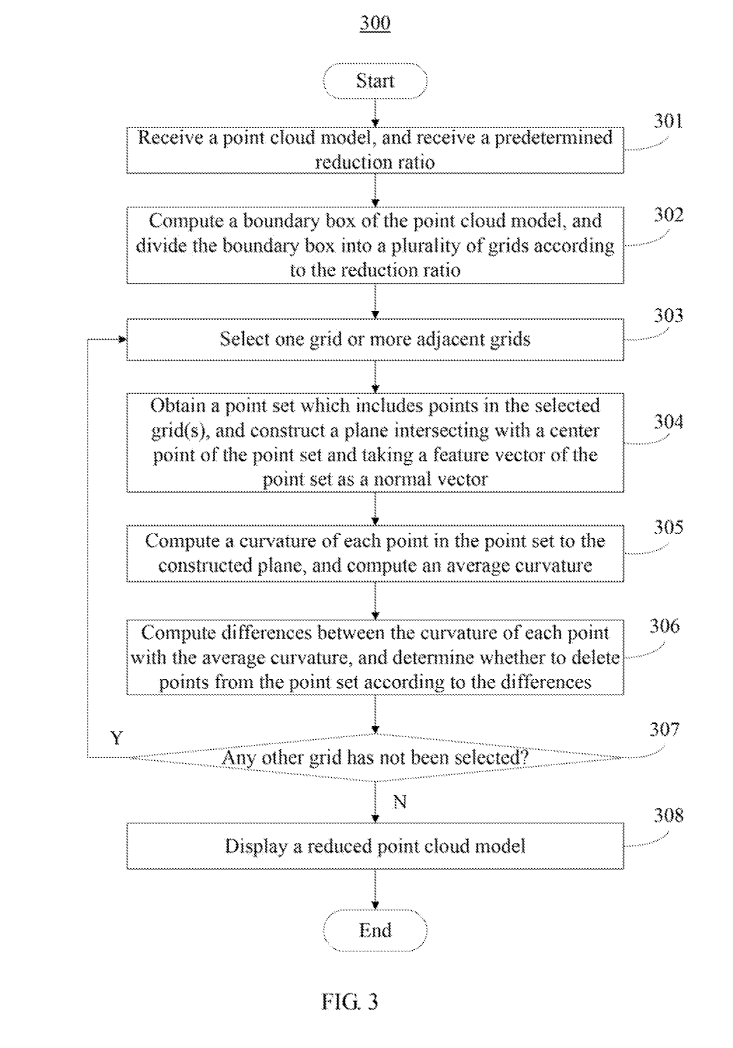

FIG. 3 is a flowchart of one embodiment of a point cloud reduction method.

Referring to FIG. 3, a flowchart is presented in accordance with an example embodiment. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change according to the present disclosure. The exemplary method 300 can begin at block 301.

At block 301, a receiving module receives a point cloud model, and receives a predetermined reduction ratio. In one embodiment, the point cloud model can be created by a three-dimensional (3D) scanner. The 3D scanner measures a large number of points on surfaces of an object. The points are defined by X, Y, and Z coordinates in a coordinate system, and intended to represent the external surface of the object. The point cloud model represented by the X, Y, and Z coordinates can be stored into a storage unit, such as a hard disk drive, a compact disc, a digital video disc, or a tape drive of a computing device. The receiving module can receive a point cloud model from the storage unit. The predetermined reduction ratio can be received according to a user input, and may be 40 percent, for example, which means 40 percentage points need to be deleted from the point cloud model.

At block 302, a first computation module computes a boundary box of the point cloud model, and divides the boundary box into a plurality of grids according to the predetermined reduction ratio. Specifically, the first computation module identifies a point which has a minimum coordinate and a point which has a maximum coordinate of the point cloud model, and determines a boundary box that can confine all points in the point cloud model according to the identified points. For example, the point which has the minimum coordinate is (pt1Min[x], pt1Min[y], pt1Min[z]), and the point which has the maximum coordinates (pt1Max[x], pt1Max[y], pt1Max[z]) , then, the boundary box is a cube defined by coordinates (pt1Min[x], pt1Min[y], pt1Min[z]), (pt1Min[x], pt1Min[y], pt1Max1[z]), (pt1Min[x], pt1Max[y], pt1Min1[z]), (pt1Min[x], pt1Max[y], pt1Max[z]), (pt1Max[x], pt1Max[y], pt1Max[z]), (pt1Max[x], pt1Max[y], pt1Min[z]), (pt1Max[x], pt1Min[y], pt1 Max[z]), and (pt1Max[x], pt1Min[y], pt1Min[z]). In one embodiment, the first computation module divides the boundary box into a plurality of grids according to step D=³\sqrt{∂L³/n}, wherein “n” represents a total number of the points in the point cloud model, L represents a length of the boundary box, and ∂ represents the predetermined reduction ratio.

At block 303, a selection module selects one grid or more adjacent grids. In one embodiment, after dividing the boundary box into a plurality of grids, the first computation module may assign an ID to each of the grids in sequence, and the selection module selects one or adjacent grids according to the ID of each of the grids. In one embodiment, a total number of the selected adjacent grids may be 2 to 27.

At block 304, a second computation module obtains a point set which includes points in the selected grid(s), and constructs a plane intersecting with a center point of the point set and taking a feature vector of the point set as a normal vector. In one embodiment, the center point of the point set is O=(ΣXᵢ/n), wherein Xi represents a coordinate of each point in the point cloud model, and n is a total number of the points in the point cloud model. The feature vector of the point set is a feature vector of a minimum value in a covariance matrix V=Σ(Xᵢ−O)*(Xᵢ−O)^{T}.

At block 305, a second computation module computes a curvature of each point in the point set to the constructed plane, and computes an average curvature according to the curvature of each point. In one embodiment, the curvature of each point can be computed using formulas as follows:

f(Xᵢ)=Σfⱼ(Xᵢ))/n;

fⱼ(Xᵢ)=dⱼ/λⱼ;

λⱼ=∥(Xᵢ−O)*t∥;

In the formulas, dj represents a distance between the point Xi and the constructed plane.

At block 306, a reduction module computes differences between the curvatures of the points in the point cloud model with the average curvature, and determines whether to delete points from the point set according to the differences. In one embodiment, when a difference between the curvature of a point P in the point cloud model and the average curvature is more than a predetermined value, the reduction module 104 determines to delete the point P from the point cloud model.

At block 307, the selection module determines if any grid has not been selected. Block 303 is repeated when any grid has not been selected. Otherwise, block 308 is implemented when all grids have been selected.

At block 308, an output module displays a reduced point cloud model on a display unit of a computing device.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A point cloud reduction method executable by at least one processor of a computing device, the method comprising:
receiving a point cloud model and a predetermined reduction ratio;
computing a boundary box of the point cloud model, and dividing the boundary box into a plurality of grids according to the predetermined reduction ratio;
selecting at least one grid;
obtaining a point set which comprises points in the selected at least one grid, and constructing a plane which is intersected with a center point of the point set and takes a feature vector of the point set as a normal vector;
computing a curvature of each of the points in the point set to the constructed plane, and computing an average curvature according to the curvature of each of the points;
computing a difference between the curvature of each of the points in the point cloud model with the average curvature, and determining one or more points to be deleted from the point set according to the differences; and
displaying a reduced point cloud model on a display unit of the computing device.

2. The method according to claim 1, wherein the boundary box is divided into the plurality of grids according to a step D=³\sqrt{∂L³/n}, wherein “n” represents a total number of the points in the point cloud model, L represents a length of the boundary box, and ∂ represents the predetermined reduction ratio.

3. The method according to claim 1, further comprising:
assigning an ID to each of the grids in sequence, and selecting the at least one grid according to the ID.

4. The method according to claim 1, wherein a point in the point cloud model is determined to be deleted when a difference between the curvature of the point with the average curvature is more than a predetermined value.

5. The method according to claim 1, wherein the center point of the point set is O=(ΣXᵢ/n), wherein Xi represents a coordinate of each point in the point cloud model, and n represents a total number of the points in the point cloud model, and the feature vector of the point set is a feature vector of a minimum value in a covariance matrix V=Σ(Xᵢ−O)*(Xᵢ−O)^{T}.

6. The method according to claim 5, wherein the curvature of each of the points in the point set is computed according to formulas of:
f(Xᵢ)=Σfⱼ(Xᵢ))/n;
fⱼ(Xᵢ)=dⱼ/λⱼ;
λⱼ=∥(Xᵢ−O)*t∥;
wherein dj represents a distance between the point Xi and the constructed plane.

7. An apparatus, comprising:
a display unit;
a control unit; and
a storage unit storing one or more programs which, when executed by the control device, causes the control device to:
receive a point cloud model and a predetermined reduction ratio;
compute a boundary box of the point cloud model, and divide the boundary box into a plurality of grids according to the predetermined reduction ratio;
select one or more grids;
obtain a point set which comprises points in the selected at least one grid, and construct a plane which is intersected with a center point of the point set and takes a feature vector of the point set as a normal vector;
compute a curvature of each of the points in the point set to the constructed plane, and compute an average curvature according to the curvature of each of the points;
compute a difference between the curvature of each of the points in the point cloud model with the average curvature, and determine one or more points to be deleted from the point set according to the differences; and
display a reduced point cloud model on the display unit.

8. The apparatus according to claim 7, wherein the boundary box is divided into the plurality of grids according to a step D=³\sqrt{∂L³/n}, wherein “n” represents a total number of the points in the point cloud model, L represents a length of the boundary box, and ∂ represents the predetermined reduction ratio.

9. The apparatus according to claim 7, further to:
assign an ID to each of the grids in sequence, and select the one or more grids according to the ID of each of the grids.

10. The apparatus according to claim 7, wherein a point in the point cloud model is determined to be deleted when a difference between the curvature of the point with the average curvature is more than a predetermined value.

11. The apparatus according to claim 7, wherein the center point of the point set is O=(ΣXᵢ/n), wherein Xi represents a coordinate of each point in the point cloud model, and n represents a total number of the points in the point cloud model, and the feature vector of the point set is a feature vector of a minimum value in a covariance matrix V=Σ(Xᵢ−O)*(Xᵢ−O)^{T}.

12. The apparatus according to claim 11, wherein the curvature of each of the points in the point set is computed according to formulas of:
f(Xᵢ)=Σfⱼ(Xᵢ))/n;
fⱼ(Xᵢ)=dⱼ/λⱼ;
λⱼ=∥(Xᵢ−O)*t∥;
wherein dj represents a distance between the point Xi and the constructed plane.

13. A non-transitory storage medium having stored thereon instructions that, when executed by a processor of a computing device, causes the processor to perform a point cloud reduction method, the method comprising:
receiving a point cloud model and a predetermined reduction ratio;
computing a boundary box of the point cloud model, and dividing the boundary box into a plurality of grids according to the predetermined reduction ratio;
selecting at least one grids;
obtaining a point set which comprises points in the selected at least one grid, and constructing a plane which is intersected with a center point of the point set and takes a feature vector of the point set as a normal vector;
computing a curvature of each of the points in the point set to the constructed plane, and computing an average curvature according to the curvature of each of the points;
computing a difference between the curvature of each of the points in the point cloud model with the average curvature, and determining one or more points to be deleted from the point set according to the differences; and
displaying a reduced point cloud model on a display unit of the computing device.

14. The non-transitory storage medium according to claim 13, wherein the boundary box is divided into the plurality of grids according to a step D=³\sqrt{∂L³/n}, wherein “n” represents a total number of the points in the point cloud model, L represents a length of the boundary box, and ∂ represents the predetermined reduction ratio.

15. The non-transitory storage medium according to claim 13, wherein the method further comprises:
assigning an ID to each of the grids in sequence, and selecting the at least one grid according to the ID.

16. The non-transitory storage medium according to claim 13, wherein a point in the point cloud model is determined to be deleted when a difference between the curvature of the point with the average curvature is more than a predetermined value.

17. The non-transitory storage medium according to claim 13, wherein the center point of the point set is O=(ΣXᵢ/n), wherein Xi represents a coordinate of each point in the point cloud model, and n represents a total number of the points in the point cloud model, and the feature vector of the point set is a feature vector of a minimum value in a covariance matrix V=Σ(Xᵢ−O)*(Xᵢ−O)^{T}.

18. The non-transitory storage medium according to claim 17, wherein the curvature of each of the points in the point set is computed according to formulas of:
f(Xᵢ)=Σfⱼ(Xᵢ))/n;
fⱼ(Xᵢ)=dⱼ/λⱼ;
λⱼ=∥(Xᵢ−O)*t∥;
wherein dj represents a distance between the point Xi and the constructed plane.
